(19) United States
(12) Patent Application Publication
(10) Pub. No.: US 2012/0213963 A1
(43) Pub. Date: Aug. 23, 2012

(54) Three dimensional camouflage system and method of manufacturing

(76) Inventor: Charley Lee, Virginia Beach, VA (US)

(21) Appl. No.: 12/932,164

(22) Filed: Feb. 19, 2011

(51) Int. Cl. B32B 3/06; B32B 3/04; D06Q 1/00; B05D 1/02; B05D 3/00; D05B 1/00; B32B 3/10; B32B 7/08

(52) U.S. Cl. 428/102; 428/136; 428/124; 156/93; 427/290; 427/288; 112/475.01

(57) ABSTRACT

A method of creating a camouflage device includes providing two bolts of lace with at least one of the bolts including pleated regions extending from one side to the other where the bolts are attached together. Each bolt of lace may include a particular pattern of stitches and/or coloring to further create more realistic three-dimensional camouflage system. Hems formed along the bolts of lace may include button holes and/or button or grommets for fastening a plurality of camouflage devices together.

There are no related patent applications.

The present application was not subject to federal research and/or development funding.

### TECHNICAL FIELD

Generally, the present invention relates to a camouflage device that may be easily and quickly deployed for hiding an individual, automobile or other machinery, and a hunting position. More specifically, the invention is a camouflage material that is manufactured by providing a first bolt of lace material having a particular color and/or hole pattern formed in the material and being die cut to create a further series of undulated openings formed in columns and running lengthwise with the first bolt of material. Strips of material connect the undulated openings and are provided between the individual undulated openings at opposite ends and sides thereof. The first bolt of lace material is thereafter pleated and fastened onto a second bolt of material via a stitching or adhesive material at various points crosswise or between the sides of the camouflage device. Channels are formed along opposite sides of the pleats and running parallel thereto. Such channels and pleats add depth to the camouflage device to create a layered effect and a novel type of three-dimensional camouflage. The second bolt of material may include a particular color or hole pattern in the lace material that is the same as the first bolt of lace material or otherwise having a different color or hole pattern than the first to complement it and create a three-dimensional camouflage device that disguises the object or person on which it is deployed. Both bolts of lace may be treated with fire retardants, anti-microbial, anti-UV treatments, or other such treatments which are beneficial for protecting the camouflage when deployed. The camouflage lace may be applicable to helmet covers, face masks, hunting cloths, tents and blinds, as well as larger sized objects such as vehicles, and observation posts.

### BACKGROUND OF THE INVENTION

Current camouflage is constructed using three to four inch square synthetic net as a substrate. Synthetic woven textile, non-synthetic woven textile, or flexible colored plastic sheet is die-cut and then attached to the net by use of a garnishment such as plastic or metal wire hooks. See e.g. Morton, U.S. Pat. Ser. No. 4,243,709, which is incorporated by reference herein and FIG. 5. Current camouflage is heavy and tends to catch air as wind passes across it. The camouflage acts as a sail and may become displaced during light winds. The present invention aims to overcome the weight and sail characteristics of camouflage and provides a novel type of camouflage and method of manufacturing it.

For purposes of this disclosure, the term “lace” is defined as an openwork fabric patterned with open holes in the work, made by machine or by hand. The lace may include asymmetrical or symmetrical openings. The term “camouflage” is defined as disguising or obscuring the appearance of objects from a distance such that an observer cannot readily recognize or discern the shape of the object. The term “net” is defined as created with open fabrics by the crossing of cords, threads, yarns, or ropes so that their intersections are knotted or looped, forming a geometrically shaped mesh, or open space of between two to four inches (2″-4″).

### SUMMARY OF THE INVENTION

The camouflage of the invention is formed entirely from a lace pattern formation fabric. That is, the camouflage comprises lace material and consists of from one to three layers. In the preferred embodiment, a first layer of fabric is substantially sixty-two inches in width and may be of any desired length. It being understood that camouflage having longer lengths may be used to disguise larger objects or to cut smaller items such as helmet coverings or articles of clothing there from. The first layer of fabric comprises a particular pattern of holes and displays a particular paint scheme

A second layer of lace material is manufactured or die cut into narrow pattern strips that are created to any desired manufacturing specifications. That is, the narrow pattern strips may be longer, shorter, wider, or narrower, as desired. The narrow pattern strips are connected together via surrounding lace material. The width of the second layer may be substantially sixty-two inches (62″), but may be wider or shorter, as desired. The die cut slits in the second layer are bridged together by strips of material substantially between two and twelve inches (2″-12″) to create a plurality of columns of die cut slits that run lengthwise in the second bolt of lace. Pleats are created in the second layer during the manufacturing process by overlapping regions of the second layer of material and stitching or adhering the overlapping regions. The second layer may then be stitched widthwise to the first layer or secured with adhesive.

A third layer optional layer having individual pattern strips may be placed atop the second layer and then sewn together on a pleating machine with a ten percent to fifty percent (10%-50%) shrinkage ratio from starting material size to the finished material size. The second layer may also be have a similar shrinkage rations if the third layer is not provided. The second and third layers are then placed atop the first layer and sewn across in a widthwise direction.

After the two or three layers of the lace material are fixed together, the edge of the fabric is trimmed. A two inch (2″) piece of webbing fabric is sewn onto the edge of the lace by first folding it in half lengthwise and then placing it so that one inch (1″) is on opposite faces of the assembled fabric and then sewn in place to create strength.

The camouflage is treated with a multipurpose coating. Soft poly-acrylic resin latex, soft polyurethane resin latex, rubber latex, fire retardant agent, UV resistant agent and pigment color are mixed together in a paint grinding machine using silicon carbide balls to create dispersion. The coating is then applied to the lace material by first dipping the fabric into the coating and drying. An airless spray printing device is used to create and design the various paint patterns on the lace. The coating is then preferably heat treated. The coating color NIR reflective percent and fire retardant percentages are created according to user specifications.

The present invention is a lace camouflage which has a greater percent of coverage as compared to the current square net method which typically has openings that are several inches in size. Further, the instant invention has a greater degree of transparency for the user when looking from within a position covered by the instant invention. The lace camouflage has up to eighty to ninety percent (80%-90%) more coverage than the current camouflage netting which obscures a covered object more complete and tricks an observer's view from a closer distance. The presently discloses lace camouflage also has less air resistance than current camouflage netting which has about forty to sixty percent (40%-60%) more solid coverage than the instant invention, resulting in a higher degree of air movement resistance or sail characteristics experienced in the prior art net style camouflage.

It is an object of the invention to teach an improved camouflage device that is easily deployed and is formed from light weight lace material which has less wind resistance when deployed than current camouflage netting.

It is an object of the invention to teach an improved camouflage device that creates a three-dimensional system that may be utilized to hide a variety of objects including automobiles, an individual, or a fixed position.

It is an object of the invention to provide a lace camouflage that has up to eighty to ninety percent (80%-90%) more coverage than the current camouflage netting and also has less air resistance than current camouflage netting.

Additional objects and advantages of the invention will be set forth in part in the description which follows, and in part will be obvious from the description, or may be learned from practicing the invention. The objects and advantages of the invention will be obtained by means of instrumentalities in combinations particularly pointed out in the appended claims.

### DESCRIPTION OF THE DRAWINGS

FIG. 1 is a perspective view of the camouflage device. FIG. 1A shows an end view of the device taken from line A-A of FIG. 1.

FIG. 2 shows a plan view of a top layer of the camouflage comprising a first bolt of lace.

FIG. 3 shows a plan view of a bottom layer of a camouflage comprising a second bolt of lace.

FIG. 4 is a view showing the die used in producing the top, layer of the camouflage.

FIG. 5 is a prior art camouflage.

### DETAILED DESCRIPTION OF THE INVENTION

The embodiments of the invention and the various features and advantageous details thereof are more fully explained with reference to the non-limiting embodiments and examples that are described and/or illustrated in the accompanying drawings and set forth in the following description. It should be noted that the features illustrated in the drawings are not necessarily drawn to scale, and the features of one embodiment may be employed with the other embodiments as the skilled artisan recognizes, even if not explicitly stated herein. Descriptions of well-known components and techniques may be omitted to avoid obscuring the invention. The examples used herein are intended merely to facilitate an understanding of ways in which the invention may be practiced and to further enable those skilled in the art to practice the invention. Accordingly, the examples and embodiments set forth herein should not be construed as limiting the scope of the invention, which is defined by the appended claims. Moreover, it is noted that like reference numerals represent similar parts throughout the several views of the drawings.

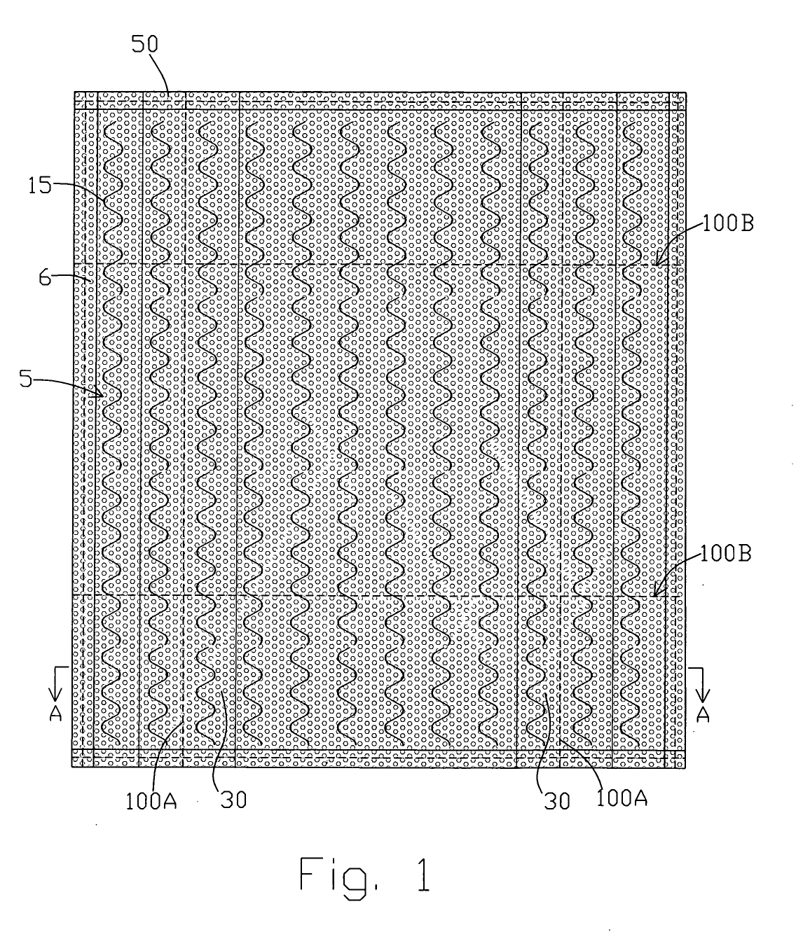

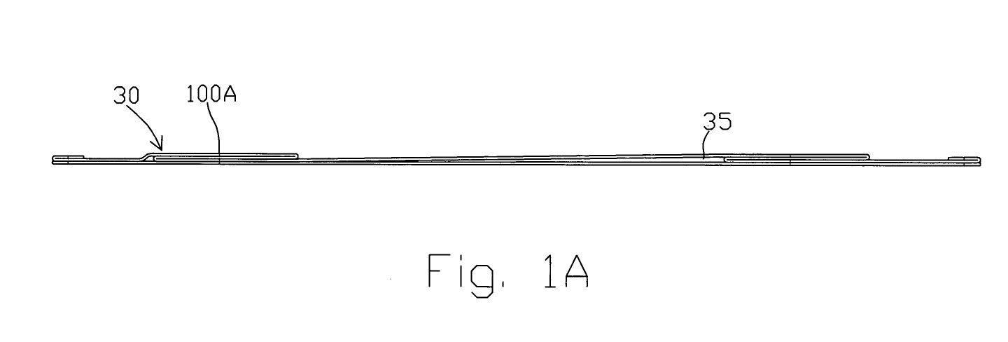

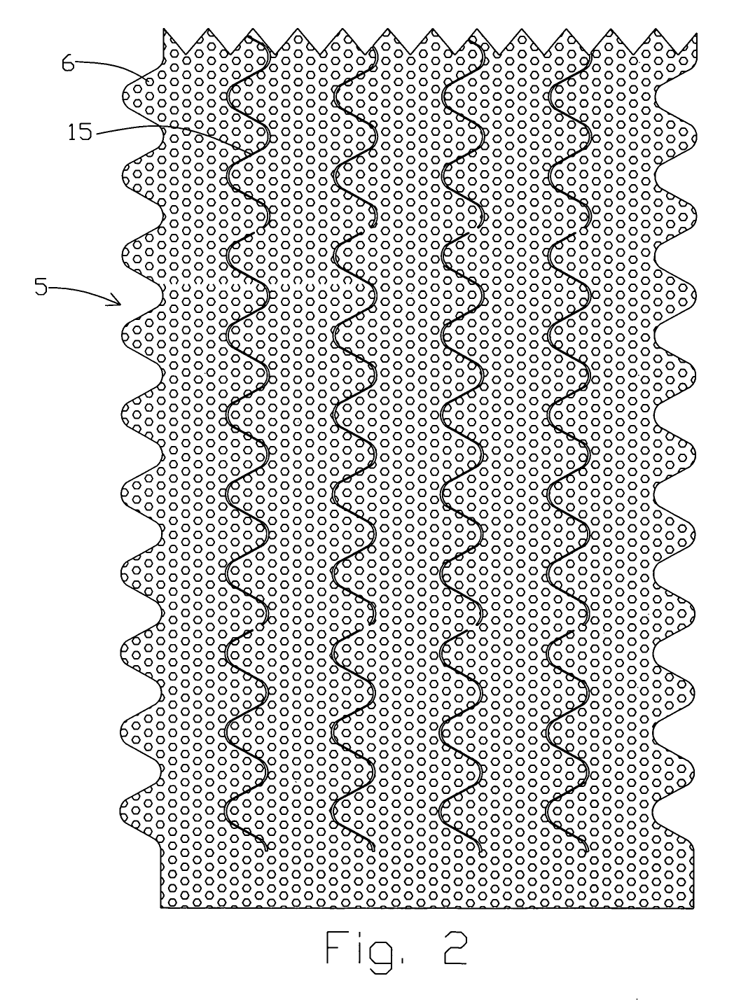

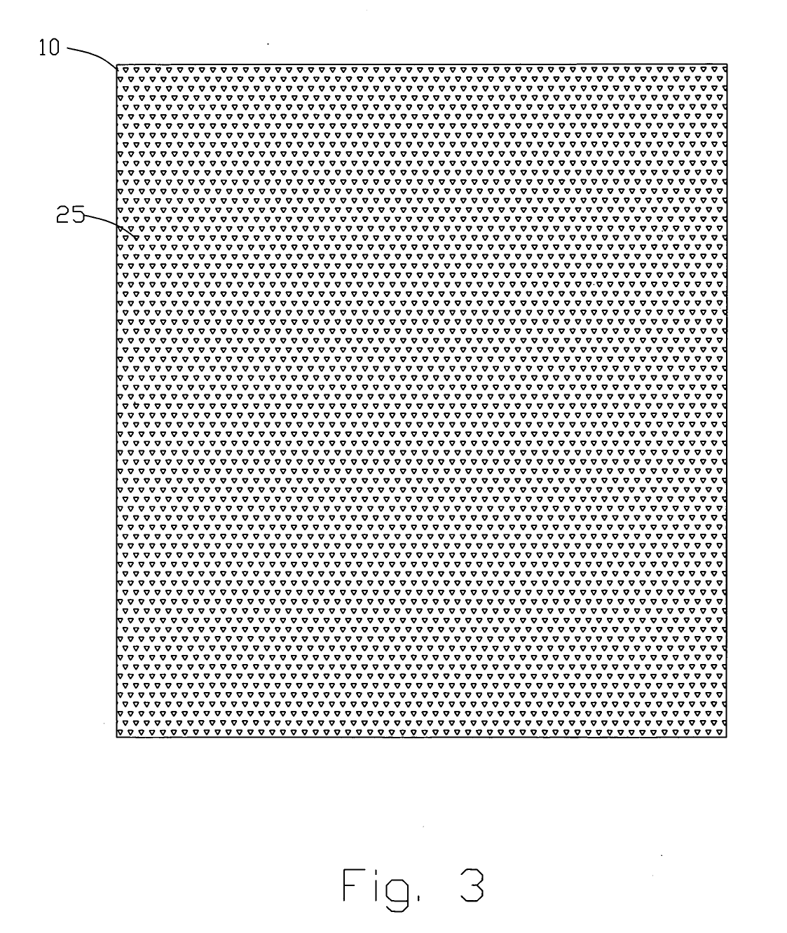

FIGS. 1 and 1A depict a perspective view of the lace camouflage device 1. The device includes a first bolt of lace 5, shown in FIG. 2, and a second bolt of lace 10 shown in FIG. 3. Hem 50 is sewn along the edges and formed from a strip of webbing or other tough material to strengthen the camouflage netting and prevent it from being easily torn. The hem 50 is preferably formed from a webbing material that is two inches (2″) in width. The webbing is folded in the center to create a centerline running lengthwise along the webbing to create one inch (1″) on either side of the centerline. The webbing is then slid onto an edge of the assembled layers of lace 5, 10 and stitched thereto.

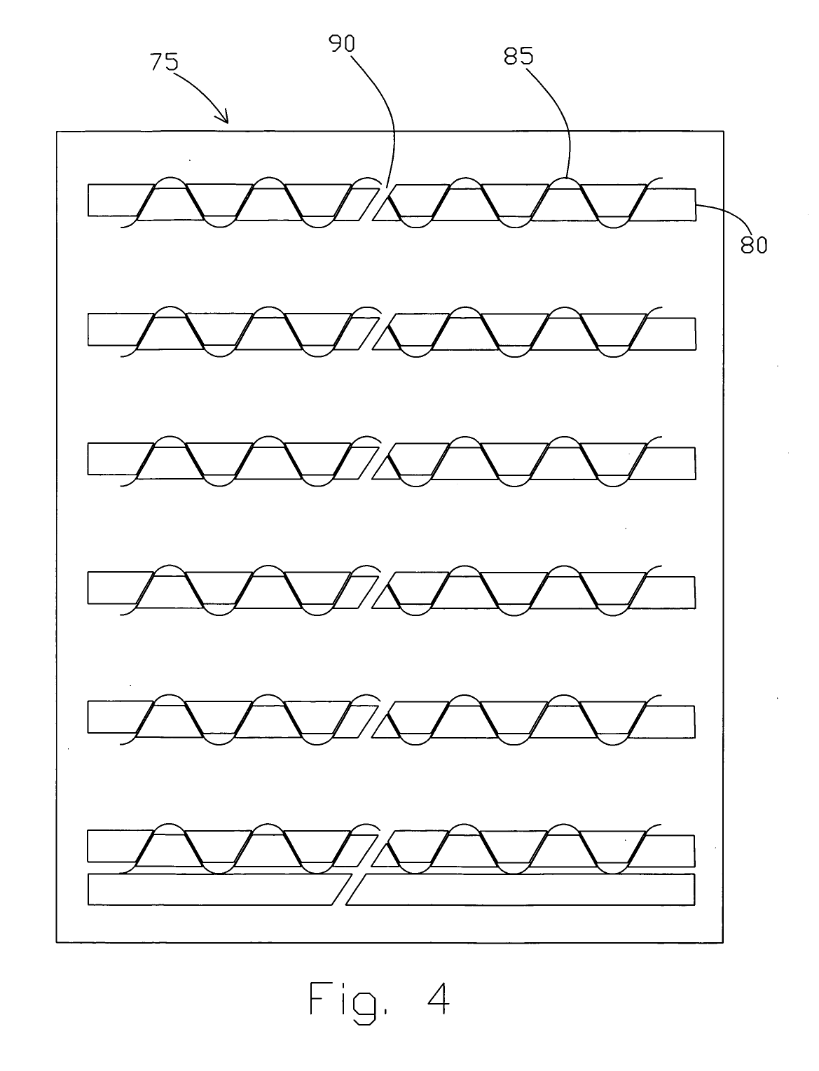

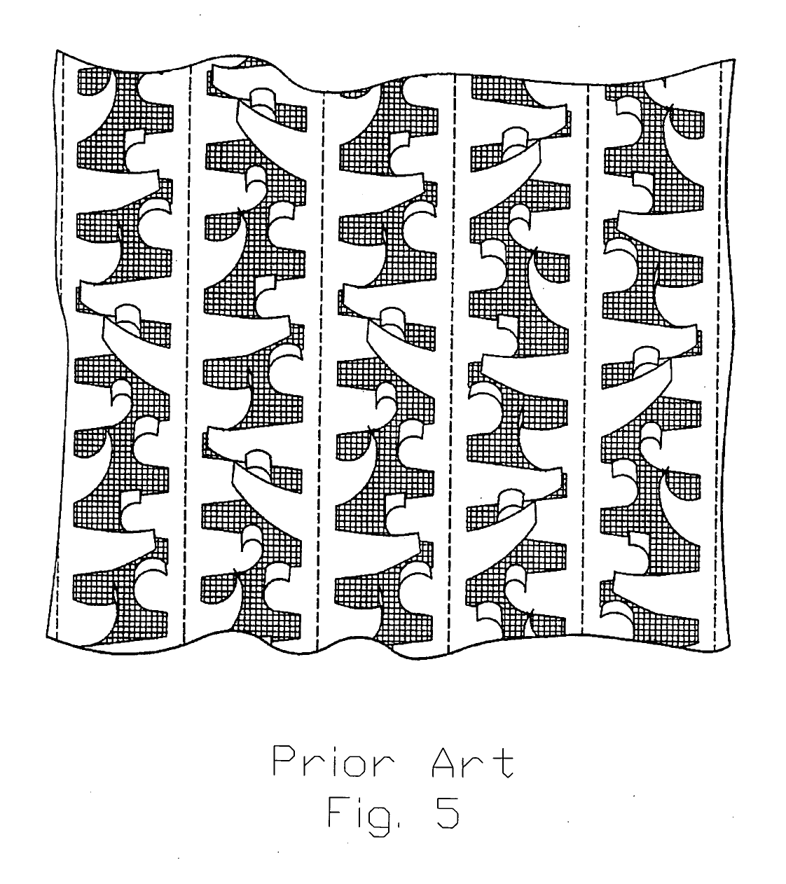

A first plurality of openings 6 is provided in the lace 5 to form a desired pattern. The pattern may be random or uniform depending on the application. A second plurality of die-cut openings is formed using a die 75, shown in FIG. 4, to create a plurality of columns running lengthwise as shown. The plurality of die-cut openings is formed in columns along the entire length of the first bolt of lace 5. The columns are separated by strips of lace on either side. Within each column, the individual die-cut openings are separated by strips of material as well. The strips of material between the columns and individual openings within the columns may be within a range of between two to twelve inches (2″-12″).

The first bolt of lace 5 is folded onto itself to create pleats 30 which are formed and stitched along the length of the lace 5. As can be seen in FIG. 1A, when the pleats 30 are formed separation regions or channels 35 are created and run along the length of each pleat 30 to create a three-dimensional element. When draped over an object, the lace 5, 10 is separated to create a three-dimension effect. Stitching 100A is provided along the length of each pleat 30. In the preferred embodiment, stitching 100B is provided widthwise at intervals along the device 1 as shown to hold the lace 5, 10 together. Adhesive or another fastening means may be substituted for the stitching 100B.

FIG. 3 shows a second bolt of lace 10 that includes a plurality of openings 25. The openings 25 are shown as being different in shape than openings 6. However, the openings 25 and 6 may be of the same shape. If a third bolt of lace is provided, it may be formed in the same shape as bolts of lace 5 and 10 with similar openings or different openings.

FIG. 4 shows a die 75 that may be utilized in forming the die cut openings 15. The die 75 includes elongated wire or metal 85 formed in the shape of undulations or waves and having rubber 80 strips arranged on sides of the metal 85 for preventing tearing of the material during the die cutting process. The bolt 5 may be pulled beneath a pressing machine having the die 75. Openings 90 are provided between strips of metal 85 as shown.

It is to be understood that the invention is not limited to the exact construction illustrated and described above, but that various changes and modifications may be made without departing from the spirit and the scope of the invention as defined in the following claims. While the invention has been described with respect to preferred embodiments, it is intended that all matter contained in the above description or shown in the accompanying drawings shall be interpreted as illustrative and not in limiting sense. From the above disclosure of the general principles of the present invention and the preceding detailed description, those skilled in the art will readily comprehend the various modifications to which the present invention is susceptible. Therefore, the scope of the invention should be limited only by the following claims and equivalents thereof.

I claim:

1. A camouflage system comprising:
a first bolt of lace comprising a first pattern of openings provided therein and a plurality of die-cut undulated openings, pleats being formed in the first bolt of lace and having a separation region running along each pleat;
a second bolt of lace comprising a pattern of openings;
a means of attaching the first bolt of lace to the second bolt of lace; and
wherein the pleats create a three-dimensional camouflage system when the camouflage system is deployed.

2. The camouflage system of claim 1 wherein said means of attaching the first bolt of lace to the second bolt of lace comprises one or more selected from a group consisting of adhesive and stitches.

3. The camouflage system of claim 1 wherein said bolts of lace further comprise fire retardants, anti-microbial agents, and anti-UV treatments.

4. The camouflage system of claim 1 wherein the first and second bolts are sewn together on a pleating machine with the second bolt having a ten percent to fifty percent (10%-50%) shrinkage ratio from starting material size to the finished material size.

5. The camouflage system of claim 1 further including a hem formed along edges of the first and second bolts of lace.

6. The camouflage system of claim 5 wherein said hem is formed from webbing which is folded lengthwise and overlapped onto edges of the first and second bolts of lace.

7. The camouflage system of claim 5 wherein said hem is one inch in width.

8. A camouflage system comprising:
a first bolt of lace having first and second faces, an outer edge and two sides, a first pattern of color provided thereon, said first bolt of lace comprising a plurality of undulated openings arranged in a longitudinal direction, pleats being formed on the first side of the first bolt of lace;
a second bolt of lace being fastened to the second face of the first bolt of lace such that channels are formed between the first and second bolts of lace, said channels extending parallel to the pleats and formed such that the first and second bolts of lace separate within the channels to create a layered effect which adds depth to the camouflage system when deployed;
a means of fastening the first bolt of lace to the second bolt of lace from side to side; and,
a hem being formed along the outer edges of the first and second bolts of lace.

9. The camouflage system of claim 8 wherein said means of fastening the first bolt of lace to the second bolt of lace comprises one or more selected from a group consisting of stitching and adhesive.

10. The camouflage system of claim 8 wherein the first bolt of lace is substantially sixty-two inches in width.

11. The camouflage system of claim 8 wherein the undulated openings are bridged together by strips of lace material within a range of substantially between two and twelve inches (2″-12″).

12. The camouflage system of claim 8 further comprising a third bolt of lace fastened to the second bolt.

13. The camouflage system of claim 8 wherein said hem comprises a two inch (2″) piece of webbing fabric sewn on the outer edge of the first and second bolts of lace.

14. The camouflage system of claim 8 further comprising a multipurpose coating consisting of one or more selected from a group consisting of soft poly-acrylic resin latex, soft polyurethane resin latex, rubber latex, a fire retardant agent, a UV resistant agent and a pigment color which are mixed together in a paint grinding machine using silicon carbide balls to create dispersion.

15. A method of manufacturing a camouflage device comprising:
providing a first bolt of lace;
cutting a plurality of undulated openings in a longitudinal direction of the first bolt of lace;
pleating the first bolt of lace to create a plurality of longitudinal pleats;
arranging the first bolt of lace atop a second bolt of lace;
folding the edges of the first and second bolts of lace and stitching to create a hem along an edge of the first and second bolts of lace; and,
fastening the first bolt of lace to the second bolt of lace widthwise such that a plurality of channels are formed between said first bolt of lace and the second bolt of lace along the longitudinal pleats.

16. The method of manufacturing a camouflage system of claim 15 further comprising creating hems that comprise a plurality of openings and attaching complementary fasteners along each him to couple the camouflage system to another camouflage system.

17. The method of manufacturing a camouflage system of claim 15 further comprising after the first and second bolts of the lace are fixed together, the edge of the fabric is trimmed and a two inch (2″) piece of webbing fabric is sewn on the edge of the first and second bolts of lace by folding the webbing fabric in half and placing it so that one inch (1″) is on arranged on both faces of first and second bolts of lace and the webbing fabric is then sewn thereto.

18. The method of manufacturing a camouflage system of claim 15 further comprising treating the first and second bolts of lace with one or more selected from a group consisting of soft poly-acrylic resin latex, soft polyurethane resin latex, rubber latex, fire retardant agent, UV resistant agent and pigment color.

19. The method of manufacturing a camouflage system of claim 18 wherein treating the first and second bolts of lace with one or more coatings selected from a group consisting of soft poly-acrylic resin latex, soft polyurethane resin latex, rubber latex, fire retardant agent, UV resistant agent and pigment color comprises mixing together in a paint grinding machine using silicon carbide balls to create dispersion and applying the coatings to the first and second bolts of lace by dipping the lace into the coating and drying.

20. The method of manufacturing a camouflage system of claim 15 further comprising using an airless spray printing device to create a paint pattern on the lace.
